(19) United States
(12) Patent Application Publication
(10) Pub. No.: US 2021/0307301 A1
(43) Pub. Date: Oct. 7, 2021

(54) SYSTEM FOR BEEHIVE HEALTH AND ACTIVITY MONITORING

(71) Applicant: X Development LLC, Mountain View, CA (US)

(72) Inventors: Szymon Zmyslony, Los Altos, CA (US); Prasad Panchalan, San Jose, CA (US); Alberto Vidal, San Jose, CA (US); Devin Spratt, Los Gatos, CA (US); Jack Hidary, Tarrytown, CA (US)

(21) Appl. No.: 17/205,843

(22) Filed: Mar. 18, 2021

Related U.S. Application Data
(60) Provisional application No. 63/004,100, filed on Apr. 2, 2020.

(51) Int. Cl. A01K 47/06; A01K 47/02; H04B 5/00; G06N 20/00; G01K 13/00; G01K 3/14

(52) U.S. Cl. CPC A01K 47/06; A01K 47/02; G01K 3/14; G06N 20/00; G01K 13/00; H04B 5/0031

(57) ABSTRACT

A system for monitoring a beehive includes a sensor bar. The sensor bar has a physical size and shape to function as a frame bar of a honeybee frame that slides into a chamber of a beehive. The sensor bar includes an enclosure having a plurality of holes, a microphone disposed within the enclosure to record sound emanating through the holes from the beehive, and at least one interior environmental sensor disposed within the enclosure to measure an interior environmental characteristic of the beehive.

### CROSS-REFERENCE TO RELATED APPLICATIONS

This application claims the benefit of Provisional Application No. 63/004,100, filed Apr. 2, 2020, the contents of which are hereby incorporated by reference.

### TECHNICAL FIELD

This disclosure relates generally to sensor systems, and in particular but not exclusively, relates to systems for monitoring beehives.

### BACKGROUND INFORMATION

A beehive is a manmade enclosure in which certain honeybee species can live, raise their brood, and generate honey. The beehive operates as the nest for the colony. Beehives are often used for commercial production of honey and pollination of commercial crops. As such, large groups of beehives are often transported around the country to different sites for pollination and honey production. Unfortunately, honeybees are suffering from a crisis that appears to be affecting bee colonies around the world. This crisis is referred to as colony collapse disorder. The reasons for this disorder are not fully understood, but environmental factors such as pollution (e.g., pesticides) or other manmade interferences are believed to be contributing factors. Accordingly, a platform that is capable of monitoring the health of a beehive to help a beekeeper better understand the health status of a bee colony and address those needs in a timely manner is desirable.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified. Not all instances of an element are necessarily labeled so as not to clutter the drawings where appropriate. The drawings are not necessarily to scale, emphasis instead being placed upon illustrating the principles being described.

FIG. 1 illustrates a system for monitoring the health of a beehive, in accordance with an embodiment of the disclosure.

FIG. 2 illustrates a sensor bar and base unit for monitoring the health of a beehive inserted into a chamber of a beehive, in accordance with an embodiment of the disclosure.

FIG. 3 illustrates how a single base unit may be shared by multiple sensor bars to provide differential monitoring across brood and honey super chambers of a beehive, in accordance with an embodiment of the disclosure.

FIG. 4A is a perspective view illustration of a sensor bar, in accordance with an embodiment of the disclosure.

FIG. 4B is a closeup illustration of ports in the sensor bar to permit interior environmental sensors and a microphone to monitor the interior of a chamber of the beehive, in accordance with an embodiment of the disclosure.

FIG. 4C is an exploded view illustration of the sensor bar, in accordance with an embodiment of the disclosure.

FIG. 5 illustrates how the sensor bar attaches to the side bars of a beehive frame, in accordance with an embodiment of the disclosure.

FIG. 6 is a flow chart illustrating a process for monitoring the health of a beehive, in accordance with an embodiment of the disclosure.

### DETAILED DESCRIPTION

Embodiments of an apparatus, system, and method of operation for a beehive monitoring system that includes a sensor bar shaped to form a frame bar of a honeybee frame are described herein. In the following description numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Embodiments of a beehive monitoring system disclosed herein include a sensor bar set in a form factor that fits a frame bar (e.g., top bar) of a honeybee frame that slides into a chamber of a beehive. The sensor bar may include a variety of different interior environmental sensors and a microphone for monitoring the health (including activity) of the colony and the interior of the beehive. In particular, the microphone records soundtracks that are related to the level of activity of the hive. In some embodiments, the sensor bar is coupled to a base unit containing a battery, a microcontroller and memory, wireless communications (e.g., cellular radio, near-field communication controller, etc.), exterior environmental sensors for monitoring the exterior environment around the beehive, as well as other sensors (e.g., global positioning sensor). The data collected from both the interior and exterior of the beehive may be collected and combined with ground truth data from a knowledgeable beekeeper using a mobile application installed on a mobile computing device. Alternatively (or additionally), the data can be sent to a cloud-based application, which is accessed remotely. The data provides the beekeeper with real-time health status of the colony and the beehive. In one embodiment, machine learning (ML) models may be trained using the interior and exterior sensor data, soundtracks, and the ground truth data collected. Once trained, ML classifiers may be incorporated into the cloud-based application and/or mobile application to monitor, track, and diagnose the health of the colony and identify stresses or other activity negatively affecting the colony. In some embodiments, the ML classifiers may even provide the beekeeper with advance warning of health issues (e.g., colony collapse disorder, loss of the queen, number of mites per 100 bees, pesticide exposure, presence of American foulbrood, etc.) and provide recommendations for prophylactic or remedial measures. In one embodiment, wireless bandwidth and battery power may be conserved by installing the ML classifier onboard the base module and only transmitting summary analysis, as opposed to the raw data, to the cloud-based application or the mobile application. These and other features of the beehive monitoring system are described below.

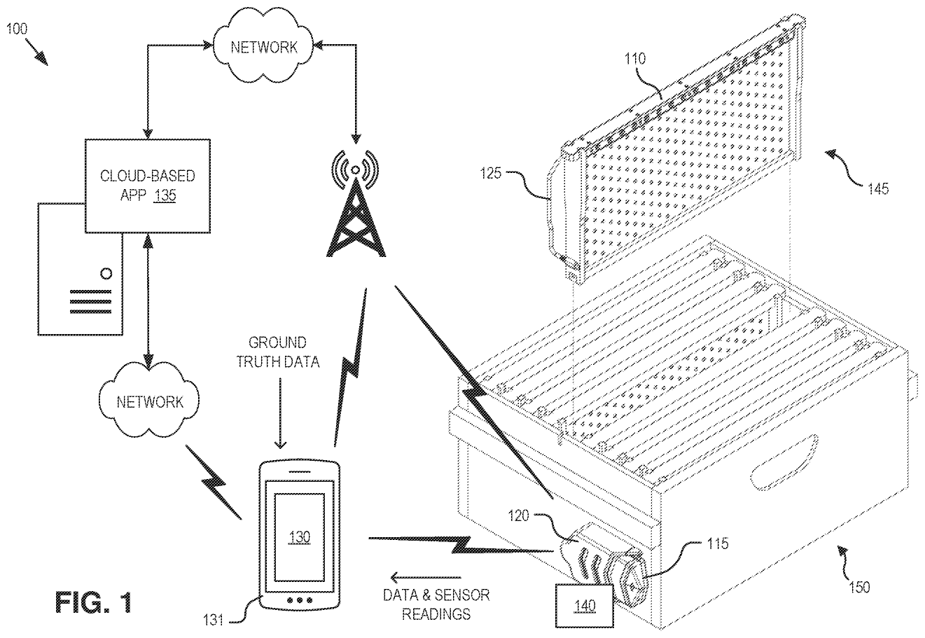

FIG. 1 illustrates a system 100 for monitoring the health of a beehive, in accordance with an embodiment of the disclosure. The illustrated embodiment of system 100 includes: a sensor bar 110, a base unit 115, a mount 120, a cable 125, a mobile application 130, a cloud-based application 135, and a local ML classifier 140.

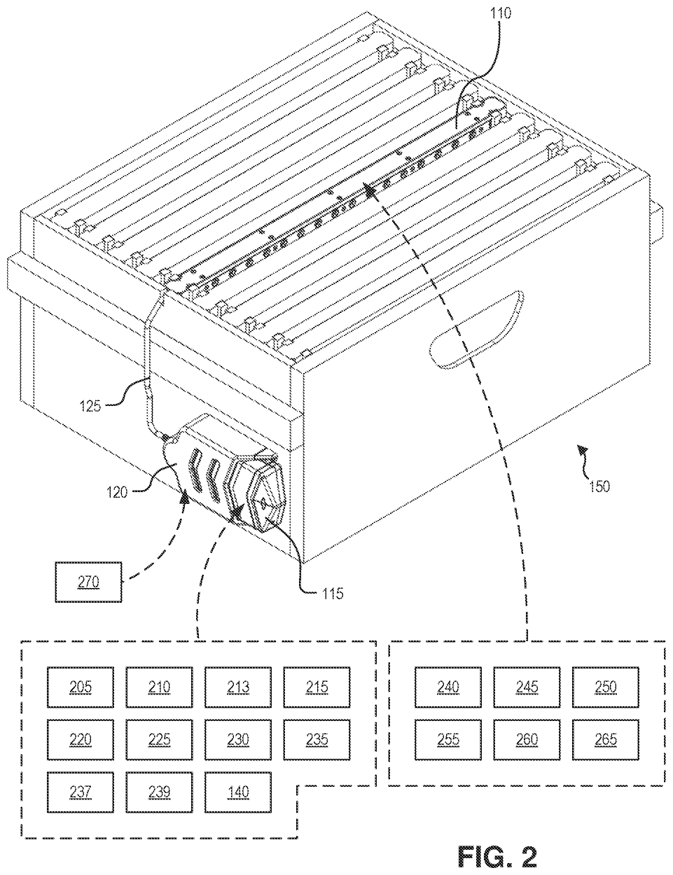

Sensor bar 110 has a form factor (e.g., size and shape) to function as a frame bar of a honeybee frame 145 that slides into a chamber 150 of a beehive (see FIG. 2). Chamber 150 may be a brood chamber so that sensor bar 110 can monitor the health status (e.g., activity level, etc.) of the brood and the queen bee, or a honey super chamber so that sensor bar 110 can monitor the health status and activity level of the worker bees. Referring to FIG. 2, sensor bar 110 is an enclosure that includes a microphone 240 to record sound emanating from within chamber 150 and through holes or ports within the enclosure. Recorded soundtracks may be analyzed to measure hive activity or loss of the queen, which may then be correlated to a health of the colony. The enclosure of sensor bar 110 may further include one or more interior environmental sensors (e.g., temperature sensor 245, humidity sensor 250, carbon dioxide sensor 255, one or more other types of chemical sensors such a pollution chemical sensor 260 and a pheromone chemical sensor 265, etc.) that measure interior environmental characteristics. In one embodiment, sensor bar 110 may even include a sensitive accelerometer to detect movement of bees detected as physical oscillations or vibrations. Sensor bar 110 is an elongated enclosure that extends a full length between, and attaches to, adjacent perpendicular bars of honeybee frame 145. In other words, sensor bar 110 operates as a structural member of the honeybee frame 145. FIG. 1 illustrates sensor bar 110 as a top bar of honeybee frame 145; however, in other embodiments, sensor bar 110 may be implemented as a side bar, a bottom bar, or a complete replacement frame.

The sensor readings and soundtracks acquired by sensor bar 110 may be recorded to memory, prior to transmission to either mobile application 130 and/or cloud-based application 135. In the illustrated embodiment, sensor bar 110 is coupled to a base unit 115 via cable 125. Cable 125 is coupled to sensor bar 110, extends out of chamber 150 and couples to base unit 115. In the illustrated embodiment, base unit 115 is attached to the exterior side of chamber 150 via a mount 120. In one embodiment, cable 125 fixes to mount 120, which includes a data/power port that connects to base unit 115 when mated to mount 120. In one embodiment, mount 120 is permanently (or semi-permanently) attached to chamber 150 and includes an identifier 270 (e.g., serial number, RFID tag, etc.) that uniquely identifies chamber 150 and/or the entire beehive, of which chamber 150 is a member. When base unit 115 slides into, or otherwise mates to mount 120, base unit 115 reads identifier 270 (or is otherwise associated therewith) and associates the sensor data and soundtracks with that particular identifier.

Base unit 115 may include a number of circuitry components for storing, analyzing, and transmitting the sensor data and soundtracks. For example, base unit 115 may include one or more of: memory 205 (e.g., non-volatile memory such as flash memory), a general purpose microcontroller 210 to execute software instructions stored in the memory, a battery 213, a cellular radio 215 (e.g., long-term evolution machine type communication or “LTE-M” radio, or another low power wide area networking technology) for cellular data communications, a global positioning sensor (GPS) 220 to determine a location of the beehive, a near-field communication (NFC) controller 225 (e.g., Bluetooth Low Energy or “BLE”) to provide near-field data communications with portable computing device 131, and one or more external environmental sensors. For example, the external environmental sensors may include a temperature sensor 230 to monitor an exterior temperature around the beehive, a humidity sensor 235 to measure exterior humidity, one or more chemical sensors 237 to measure pollution exterior to the beehive, one or more chemical sensors 239 to measure exterior pheromones, or otherwise. In one embodiment, base unit 115 may also include an accelerometer to detect movements of the chamber or the beehive. These movements can be used to track beehive maintenance and even provide theft detection or detection of interference by wild animals.

During operation, base module 115 stores and transmits the sensor data and soundtracks, and in some embodiments may also provide local data processing and analysis. Mobile application 130 may help the beekeeper or other field technician find and identify a particular beehive via the wireless communications and the GPS sensor disposed onboard base unit 115. The onboard NFC controller may be used to provide tap-to-communicate services to a beekeeper carrying portable computing device 131. The stored sensor data and soundtracks may be wirelessly transferred to mobile application 130 using NFC protocols. In some embodiments, mobile application 130 may solicit ground truth data from a knowledgeable beekeeper and associate that ground truth data with the sensor data and soundtracks, as well as with other ancillary data (e.g., date, time, location, weather, local vegetation/crops being pollinated, etc.). The sensor data, soundtracks, ground truth data, and ancillary data may be analyzed with a trained ML classifier integrated with mobile application 130 or even by a trained ML classifier 140 disposed onboard base unit 115. By locally executing a trained ML classifier 140 either onboard base unit 115 or one integrated with mobile application 130, classified results may be pushed up to cloud-based application 135, as opposed to the raw data, which saves bandwidth and reduced power consumption on battery 213.

Cloud-based application 135 may be provided as a backend cloud-based service for gathering, storing, and/or analyzing data received either directly from base unit 115 or indirectly from mobile application 130. Initially, the raw data and ground truth data may be transmitted to cloud-based application 135 and used to train a ML model to generate one or more trained ML classifiers, such as ML classifier 140. However, once sufficient data has been obtained and a ML classifier trained, ML classifier 140 may be installed directly onto base unit 140 (or integrated with mobile application 130). The onboard ML classifiers can then locally analyze and classify the health status of each beehive and merely provide summary data or analysis to cloud-based application 135 or mobile application 130, thereby reducing bandwidth and power consumption. The summary data or analysis may provide a beekeeper with real-time tracking of data and health statuses, environmental stress alerts, prophylactic or remedial recommendations, etc. The ML classifiers (e.g., ML classifier 140) or ML models may take soundtracks, interior sensor data (e.g., interior temperature, humidity, carbon dioxide, chemical pollution, pheromone levels, etc.) and exterior sensor data (e.g., exterior temperature, humidity, carbon dioxide, chemical pollution, pheromone levels, GPS location, weather conditions, etc.) along with ground truth data and ancillary data, as input for both training and real-time classifying. The ground truth data may include the observations, conclusions, and informed assumptions of a knowledgeable beekeeper or field technician observing or managing a given beehive. The combined data input from the carbon dioxide sensors, temperature sensors, humidity sensors, audio sensors, and chemical sensors may be used by the ML classifier to make predictions about colony collapse disorder, loss of a queen bee, the presence of American foulbrood bacteria, the number of mites per bee population, as well as other colony stresses.

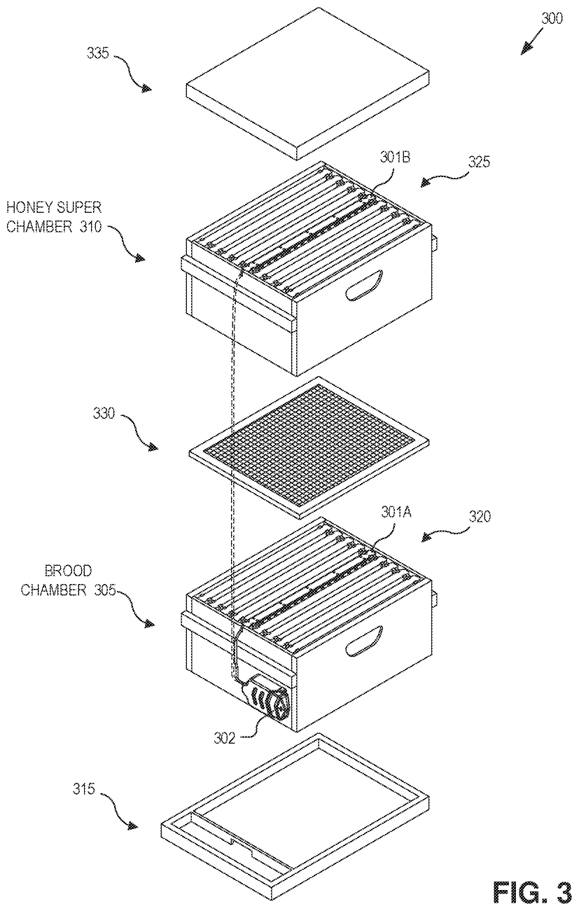

FIG. 3 illustrates a beehive 300 including a brood chamber 305 and a honey super chamber 310, in accordance with an embodiment of the disclosure. As illustrated, brood chamber 305 sits over bottom board 315 that may include an entrance, a mite floor, and a screen wire, as are common in the art of beekeeping. Brood chamber 305 includes a plurality of brood frames 320, one of which includes a sensor bar 301A. Similarly, honey super chamber 310 includes a plurality of honey frames 325, one of which includes a sensor bar 301B. Generically, brood frames 320 and honey frames 325 are referred to as honeybee frames. Although FIG. 3 illustrates just one honey super chamber 310 stacked over a single brood chamber 305, it should be appreciated that beehive 300 may include multiple stacked brood chambers 305 and multiple stacked honey super chambers 310. In the illustrated embodiment, brood chambers 305 and the honey super chambers 310 are separated by a queen excluder 330. Finally, the top of beehive 300 is capped by a cover 335, which may include a top cover and an inner cover (not separately illustrated).

FIG. 3 illustrates how a single beehive 300 may be monitored using multiple sensor bars 301 to provide differential sensing and analysis within a given beehive 300. FIG. 3 illustrates two sensor bars 301A and B providing differential data sensing and analysis vertically between brood chamber 305 and honey super chamber 310; however, it is anticipate that multiple sensor bars may even be installed into a single chamber to provide differential sensing and analysis laterally across and within a single chamber. The use of multiple sensor bars distributed both vertically and/or laterally across a single beehive 300 may provide finer grain data acquisition, thus improved hive analysis for generating ML training data and even ML classification during regular operation.

As illustrated in FIG. 3, multiple sensor bars 301A and B may couple to and share a common base unit 302. Although FIG. 3 illustrates wired connections between base unit 302 and sensor bars 301, in other embodiments, wireless connections between sensor bars 301 and base unit 302 may be implemented. For example, sensor bars 301 may incorporate their own batteries and use low power wireless data communications to base unit 302. Alternatively (or additionally), base unit 302 may also provide inductive power to sensor bars 301. In yet other embodiments, the cellular radio, battery, GPS sensor, memory, and/or microcontroller may be entirely integrated into the sensor bar, and the base unit may simply include exterior environmental sensors and potentially a GPS or cellular antenna. In yet other embodiments, the exterior base unit may be entirely omitted. In another embodiment, the chambers of beehive 300 may be modified to include power rails that distribute power from a battery pack contained in or on the box structure of beehive 300 to one or more sensor bars. In some embodiments, low power wireless mesh networking protocols may be used to link multiple sensor bars within a particular beehive or across a field of beehives to provide a single ingress/egress data gateway for external network communications.

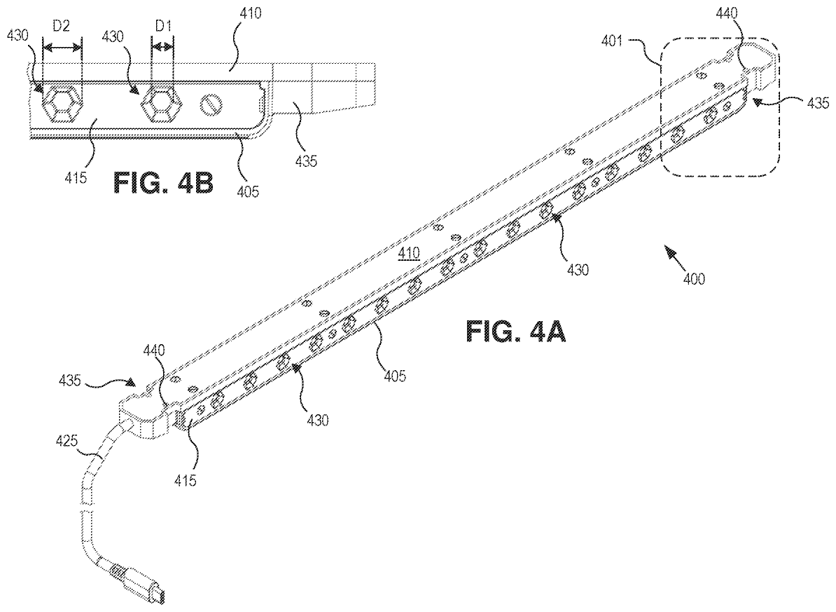

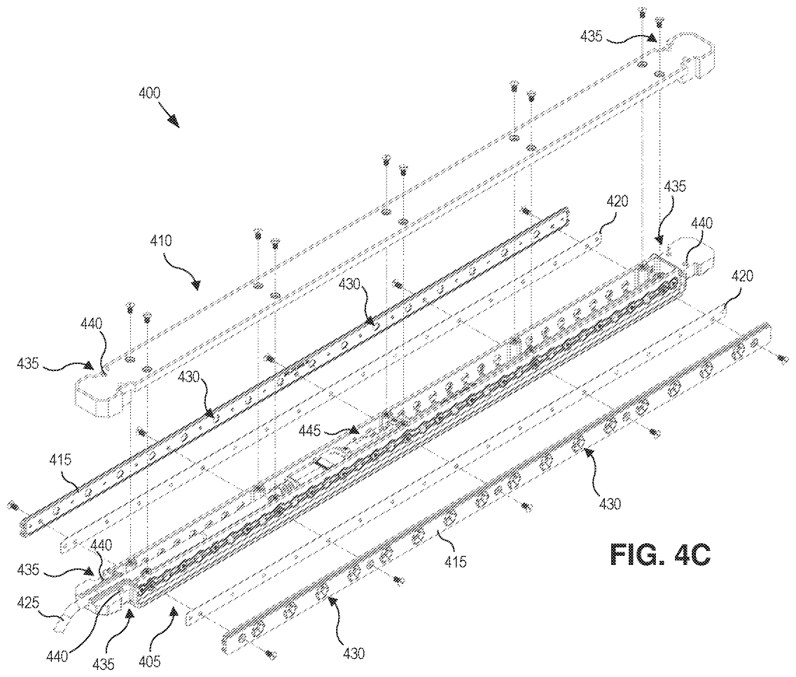

FIGS. 4A-C illustrate an example sensor bar 400, in accordance with an embodiment of the disclosure. Sensor bar 400 represents one possible implementation of sensor bars 110, 301A, or 301B, illustrated in FIG. 1 or 3. FIG. 4A is a perspective view illustration of senor bar 400, FIG. 4B is an expanded front elevation view of region 401 in FIG. 4A, and FIG. 4C is an exploded view illustration of sensor bar 400. In the illustrated embodiment, sensor bar 400 includes main member 405, a top member, 410, side members 415, screens 420, a cord 425, and a circuit board 445 with electronics disposed thereon. The illustrated embodiment of side members 415 include holes 430. Main member 405 and top member 410 includes recesses 435 and nail holes 440.

Main member 405 and top member 410 collectively form an elongated enclosure, which in the illustrated embodiment is held together with mechanical fasteners (e.g., screws). The elongated enclosure houses circuit board 445 upon which one or more microphones and various interior environmental sensors (e.g., humidity sensor, temperature sensor, carbon dioxide sensor, chemical sensors for pollution detection, chemical sensors for pheromone detection, etc.) are disposed. In one embodiment, main member 405, top member 410, and side members 415 are fabricated of food grade plastic (e.g., polypropylene, high density polyethylene, etc.), metal (e.g., stainless steel, aluminum, etc.), wood, or otherwise.

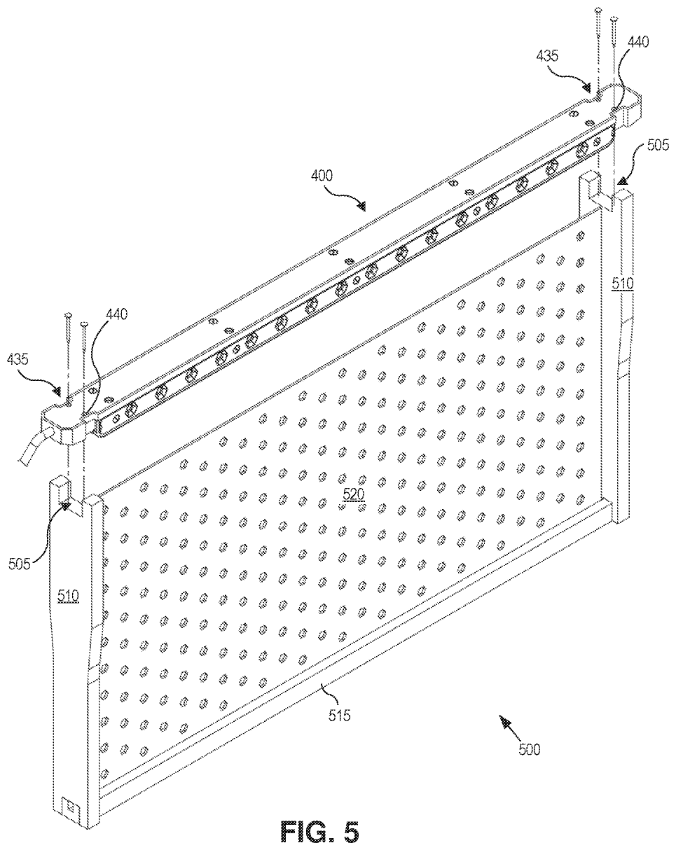

The elongated enclosure has a form factor to function as a bar (e.g., top bar) of a honeybee frame 500 (see FIG. 5). In particular, main member 405 includes two recesses 435 on each end that mate to corresponding recesses 505 on side bars 510 of honeybee frame 500. Mechanical fasteners (e.g., nails) are driven through nail holes 440 to secure sensor bar 400 to side bars 510. Accordingly, sensor bar 400 along with side bars 510 and bottom bar 515 hold a substrate 520 in place and collectively form honeybee frame 500, which slides into a chamber of a beehive. Substrate 520 is typically fabricated as a wax or wax covered plastic sheet, wires, strings, etc. and is the underlying substrate upon which bees form their honeycomb structures to raise brood and stockpile honey.

Returning to FIG. 4C, side members 415 attach to either side of main member 405 and sandwich screens 420 therebetween. Side members 415 are designed as an optional subassembly that enables easy removal and/or replacement for cleaning (e.g., cleaning clogged holes 430) without having to disassemble the enclosure formed by main member 405 and top member 410. Screens 420 run along the length of side members 430 and extend behind holes 430. Screens may be fabricated of a mesh material that keeps bees and debris out of the enclosure while permitting sound and air to pass through holes 430. The elongated structure with distributed holes 430 running the length provides good exchange of air and sound between the interior of the beehive and the enclosure. This provides improved environmental coupling between the electronics on circuit board 445 and the beehive. Cable 425 extends into the enclosure from a distal end and couples to circuit board 445 and by extension the interior environmental sensors 445 and microphone(s) 240. Cable 425 may be implemented using a standardized cable connector cable of transporting data and power, such as USB-C or otherwise.

Turning to FIG. 4B, in one embodiment, holes 430 are sized to discourage bees from covering the holes with wax or propolis to maintain clear, unimpeded environmental coupling. In various embodiments, holes 430 have a diameter ranging between 4.5 mm and 9.5 mm, which is a dimensional range that has been found to discourage bees from this activity. In one embodiment, holes 430 are flared to prevent debris from accumulating in the hole and have an inner diameter D1 of approximately 4.5 mm and a flared outer diameter of approximately 9.5 mm. While FIGS. 4A-C illustrate 16 holes on each side of sensor bar 400, it should be appreciated that more or less holes may be used.

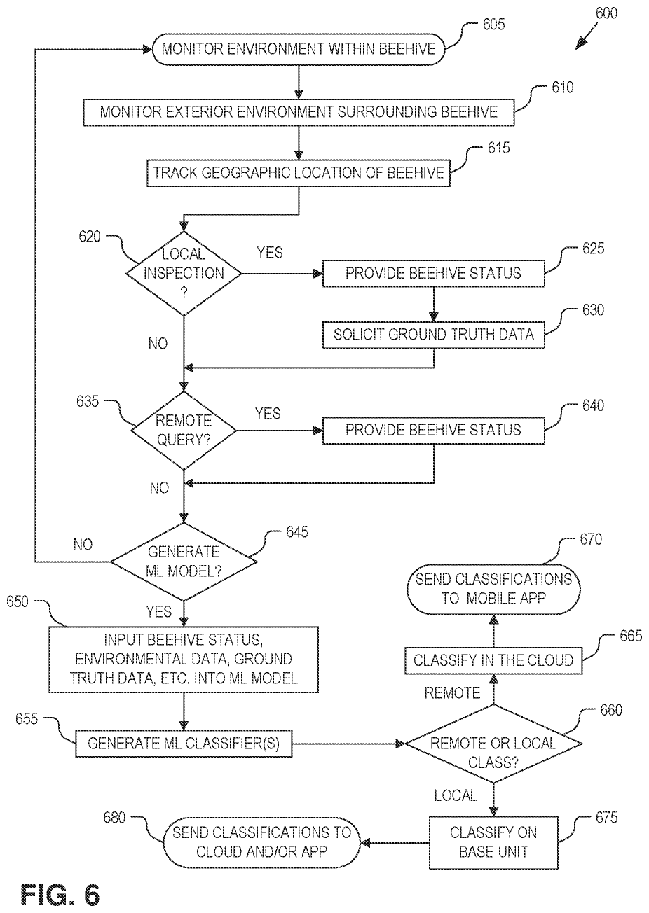

FIG. 6 is a flow chart illustrating a process 600 for monitoring the health status (including activity level) of a beehive, in accordance with an embodiment of the disclosure. The order in which some or all of the process blocks appear in process 600 should not be deemed limiting. Rather, one of ordinary skill in the art having the benefit of the present disclosure will understand that some of the process blocks may be executed in a variety of orders not illustrated, or even in parallel.

In a process block 605, sensor bar 110 operates to monitor (e.g., continuously, periodically, or on-demand) the interior of a beehive, such as beehive 300. In various embodiments, monitoring the interior environment includes recording hive activity via microphone 240 and/or monitoring various other interior environmental characteristics using interior environmental sensors 245-265. In one embodiment, the data (e.g., recorded soundtracks and sensor readings) are recorded into memory 205 of base unit 115 for storage and/or processing. In a process block 610, base unit 115 operates to monitor (e.g., continuously, periodically, or on-demand) the exterior environment surrounding the beehive. In various embodiments, monitoring the exterior environment includes monitoring various exterior environments characteristics using exterior environmental sensors 230-239. Again, the exterior sensor data may be temporarily stored into onboard memory 205. Along with the sensor data, base unit 115 may identify the geographical location of the beehive using GPS 220 (process block 615). Since commercial beehives are often transported great distances throughout the year, location tracking can help correlate sensor readings to geographic location, local weather, local crops/vegetation, known sources of pollution, etc.

In one embodiment, a beekeeper (or other field technician) can physically inspect individual beehives using mobile computing device 131 equipped with NFC capabilities and mobile application 130. For example, the beekeeper can tap or scan base unit 115 with mobile computing device 131 (decision block 620) to obtain the data and sensor readings related to the status and health of a particular beehive. If the beekeeper is knowledgeable, ground truth data related to the beekeeper's own observations of the hive may also be solicited by mobile application 130 (process block 630). After collecting the data (e.g., sensor readings, soundtracks, ground truth data, and any other ancillary data), mobile application 130 may transmit the data (or summarized analysis thereof) to cloud-based application 135. Alternatively (or additionally), base unit 115 may be physically removed from mount 120 for charging and large data download to a computer via a wired connection (e.g., USB-C, etc.), and then base unit 115 is subsequently mated back to mount 120.

If a remote query of a particular beehive (or group of beehives) is desired (decision block 635), then the health status of the beehive may be obtained via cellular data communications. For examples, the remote query may come from cloud-based application 135 as part of a routine, periodic, or on-demand retrieval of data. Alternatively, a user of mobile application 130 may request a remote query of the health status of a particular beehive or group of beehives. A remote query from mobile application 130 may come indirectly via cloud-based application 135, or operate as a direct peer-to-peer communication session with base unit 115.

In embodiments using machine learning to model and classify the health status of a beehive (decision block 645), the collected data (e.g., interior and exterior environmental sensor data, GPS location, soundtracks, etc.) is combined with the collected ground truth data and other ancillary data as input into a ML model or neural network for training (process block 650) to generate a trained ML classifier (process block 655). In a decision block 660, the ML classifier may be operated remotely by cloud-based application 135 (process block 665) and the analysis sent to mobile application 130 for review by the beekeeper (process block 670). Alternatively (or additionally), the classification may be executed locally onboard base unit 115 by ML classifier 140 (process block 675). In this embodiment, base unit 115 sends the classifications and/or recommendations to cloud-base application 135 and/or mobile application 130 without sending some or all of the underlying raw data (process block 680). This embodiment has the benefit of conserving power and bandwidth due to continuous, large volume transfers of the raw data. Of course, ML application 140 may also be integrated with mobile application 130 as a sort of semi-local classification.

The processes explained above are described in terms of computer software and hardware. The techniques described may constitute machine-executable instructions embodied within a tangible or non-transitory machine (e.g., computer) readable storage medium, that when executed by a machine will cause the machine to perform the operations described. Additionally, the processes may be embodied within hardware, such as an application specific integrated circuit (“ASIC”) or otherwise.

A tangible machine-readable storage medium includes any mechanism that provides (i.e., stores) information in a non-transitory form accessible by a machine (e.g., a computer, network device, personal digital assistant, manufacturing tool, any device with a set of one or more processors, etc.). For example, a machine-readable storage medium includes recordable/non-recordable media (e.g., read only memory (ROM), random access memory (RAM), magnetic disk storage media, optical storage media, flash memory devices, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. A system for monitoring a beehive, comprising:
a sensor bar having a size and a shape to function as a frame bar of a honeybee frame that slides into a chamber of the beehive, wherein the sensor bar includes:
an enclosure having a plurality of holes;
a microphone disposed within the enclosure to record sound emanating through the holes from the beehive; and
at least one interior environmental sensor disposed within the enclosure to measure an interior environmental characteristic of the beehive.

2. The system of claim 1, wherein the holes each have an opening with a diameter ranging between 3.4 mm and 9.5 mm to discourage bees from covering the holes with wax or propolis.

3. The system of claim 1, wherein the enclosure comprises an elongated enclosure that extends a full length between and attaches to adjacent perpendicular bars of the honeybee frame.

4. The system of claim 1, wherein the frame bar comprises a top bar of the honeybee frame.

5. The system of claim 1, wherein the at least one interior environmental sensor comprises a first temperature sensor to measure an internal temperature of the beehive.

6. The system of claim 5, wherein the at least one interior environmental sensor further comprises at least one of a carbon dioxide sensor to measure carbon dioxide within the beehive, a humidity sensor to measure humidity within the beehive, a first chemical sensor to measure chemical pollutants within the beehive, or a second chemical sensor to measure pheromones within the beehive.

7. The system of claim 1, wherein the sensor bar further comprises:
one or more screens disposed within the enclosure and extending across the holes to keep bees and debris out of the enclosure while permitting the sound and air to pass through the holes.

8. The system of claim 1, further comprising a base unit configured to mount on an exterior of the beehive and connect to the sensor bar, the base unit including:
memory for recording sensor readings and soundtracks received from the sensor bar;
a battery for powering the sensor bar;
at least one exterior environmental sensor to measure an exterior environmental characteristic outside of the beehive; and
a microcontroller coupled to the memory and the at least one exterior environmental sensor.

9. The system of claim 8, wherein the at least one exterior environmental sensor comprises:
a second temperature sensor to measure an exterior temperature around the beehive.

10. The system of claim 8, wherein the base unit further comprises:
a global positioning sensor (GPS) to determine a location of the beehive;
a cellular radio to provide cellular data communication; and
a near-field communication (NFC) controller to provide NFC data communication.

11. The system of claim 10, further comprising:
a mobile application installable on a portable computing device, the mobile application configured to cause the portable computing device to communicate with the base unit via the NFC controller and solicit ground truth data related to the beehive from an operator of the portable computing device; and
a cloud-based application configured to gather the ground truth data from the mobile application and train a machine learning model based at least in part upon the ground truth data and outputs from the microphone, the at least one interior environmental sensor, and the at least one exterior environmental sensor.

12. The system of claim 8, further comprising:
a machine learning (ML) classifier stored within the memory and executable by the microcontroller to classify a health status of the beehive, wherein the ML classifier is configured to classify the health status of the beehive based at least upon outputs from the microphone, the at least one interior environmental sensor within the sensor bar, and the at least one exterior environmental sensor within the base unit.

13. The system of claim 8, further comprising:
a mount for securing to the beehive, the mount shaped to removably mate with the base unit, wherein the mount includes an identifier that uniquely identifies the beehive to the base unit; and
a cable that extends from the mount to the sensor bar and provides a data connection and a power connection between the base unit and the sensor bar when the base unit is mated to the mount.

14. A beehive, comprising:
a brood chamber including a plurality of brood frames disposed therein;
a honey super chamber stacked above the brood chamber and including a plurality of honey frames disposed therein; and
a sensor bar having a size and a shape to function as a frame bar of one of the brood or honey frames, wherein the sensor bar includes:
an enclosure having a plurality of holes;
a microphone disposed within the enclosure to record sound emanating through the holes from the brood chamber or the honey supper chamber; and
at least one interior environmental sensor disposed within the enclosure to measure an interior environmental characteristic of the beehive.

15. The beehive of claim 14, wherein the holes in the enclosure each have an opening with a diameter ranging between 4.5 mm and 9.5 mm to discourage bees from covering the holes with wax or propolis.

16. The beehive of claim 14, wherein the at least one interior environmental sensor further comprises:
a first temperature sensor to measure an internal temperature of the beehive; and
at least one of a carbon dioxide sensor to measure carbon dioxide within the beehive, a humidity sensor to measure humidity within the beehive, a first chemical sensor to measure chemical pollutants within the beehive, or a second chemical sensor to measure pheromones within the beehive.

17. The beehive of claim 14, wherein the sensor bar further comprises:
one or more screens disposed within the enclosure and extending across the holes to keep bees and debris out of the enclosure while permitting sound and air to pass through the holes.

18. The beehive of claim 14, further comprising a base unit configured to mount on an exterior of the beehive and connect to the sensor bar, the base unit including:
memory for recording sensor readings and soundtracks received from the sensor bar;
a battery for powering the sensor bar;
at least one exterior environmental sensor to measure an exterior environmental characteristic outside of the beehive; and
a microcontroller coupled to the memory and the at least one exterior environmental sensor.

19. The beehive of claim 18, wherein the at least one exterior environmental sensor comprises:
a second temperature sensor to measure an exterior temperature around the beehive.

20. The beehive of claim 18, wherein the base unit further comprises:
a global positioning sensor (GPS) to determine a location of the beehive;
a cellular radio to provide cellular data communication; and
a near-field communication (NFC) controller to provide NFC data communication for reading the sensor readings and the soundtracks with a portable computing device.

21. The beehive of claim 18, further comprising:
a machine learning (ML) classifier stored within the memory and executable by the microcontroller to classify a health status of the beehive, wherein the ML classifier is configured to classify the health status of the beehive based at least upon outputs from the microphone, the at least one interior environmental sensor within the sensor bar, and the at least one exterior environmental sensor within the base unit.

22. The beehive of claim 18, further comprising:
a mount secured to an outside of the honey super chamber or the brood chamber, the mount shaped to removably mate with the base unit, wherein the mount includes an identifier that uniquely identifies the beehive to the base unit; and
a cable that extends from the mount to the sensor bar and provides a data connection and a power connection between the base unit and the sensor bar when the base unit is mated to the mount.

23. The beehive of claim 18, wherein the sensor bar is disposed within the brood chamber, the beehive further comprising:
an additional sensor bar disposed within the honey super chamber and coupled to the base unit.
